(19) United States
(12) Patent Application Publication
(10) Pub. No.: US 2006/0213101 A1
(43) Pub. Date: Sep. 28, 2006

(54) Temporary themed wallpaper banner and uses thereof

(76) Inventors: Timothy Sobonya, Mentor, OH (US); Danielle Sobonya, Mentor, OH (US)

Correspondence Address: Justin S. Rerko & Associates, LLC, 19836 Ellsworth Drive, Strongsville, OH, 44149, US

(21) Appl. No.: 11/086,159

(22) Filed: Mar. 22, 2005

(51) Int. Cl. G09F 7/12

(52) U.S. Cl. 40/594

(57) ABSTRACT

A removable wallpaper banner having themed indicia thereon. The wallpaper generally includes an elongate and substantially flat rectangular sheet of material comprising a first surface and a second surface, wherein the second surface is disposed in opposition to the first surface; a non-permanent and removable adhesive associated with the second surface of the sheet of material and adapted for non-permanently and removably associating the sheet of material with a building structure wall; and a plurality of themed indicia associated with the first surface of the sheet of material. The themed indicia is related to at least one of a holiday-related theme, such as a Christmas-related theme, a Thanksgiving-related theme, a Halloween-related theme, an Easter-related theme, a 4^{th} of July-related theme, a St. Patrick's Day-related theme, a New Year's-related theme, and a Valentine' Day-related theme, a seasonal theme, a birthday-related theme, a birth-related theme, a wedding-related theme, a personal hobby-related theme, a patriotism-related theme, and a sports affiliation-related theme.

### FIELD OF THE INVENTION

The present invention relates to temporary wallpaper. More particularly, the present invention relates to temporary wallpaper banner featuring themed indicia thereon, and uses thereof.

### BRIEF DISCUSSION OF THE RELATED ART

There are a number of conventionally employed techniques and materials for decorating dwelling structure walls. Paint is a widely used material for decorating a bare wall in accordance with an individual's taste and preferences. Paneling is another widely used material, which is generally employed as a bare wall overlay that is generally mechanically fastened directly to a wall for decorating and changing the appearance of the same. Wallpaper is yet another generally ubiquitously employed material for decorating walls. Wallpaper is a particularly preferred material, as it is widely available in a broad range of artistic designs, which are generally difficult and/or impracticable to create on a wall with paint.

Yet another material widely employed is wallpaper banner. As conventionally known, wallpaper banner is typically provided as a rectangular and elongate member generally adapted to be disposed atop a wall, especially a wall having paint and/or wallpaper thereon. Wallpaper banner typically features a wider range of artistic designs than typically featured on traditional wallpaper, such as fanciful cow designs, and the like.

A complication associated with conventional wall decoration materials is the adhesives employed therewith. For example, paint is its own adhesive, and is not generally removable from a wall once applied and must be covered with another material to change the appearance of the wall. Wallpaper is applied to a wall through an aggressive adhesive, which adhesive usually requires extensive effort to be removed. Thus, once wallpaper is applied to a wall, it is typically left in position for a substantial amount of time.

Wall decoration is one approach often used by individuals to decorate the environment in which they live. Many individuals also enjoy decorating their environment in connection with various events, such as holidays (e.g., Christmas, New Year's Eve, Thanksgiving, etc.), birthdays, marriages, and the like. For such events, individuals typically position decorative items, such as Christmas trees, presents, etc., around their environment as an effort to enhance the festivity of the celebration. However, because of the limited duration that events are typically celebrated, and because of the adhesives typically employed for wall decoration materials, wallpaper, wallpaper banner and other wall decoration materials have not been explored as vehicles for celebrating events.

### BRIEF SUMMARY OF THE INVENTION

In accordance with one aspect, the present invention provides a removable wallpaper banner having themed indicia thereon. The wallpaper banner generally includes an elongate and substantially flat rectangular sheet of material comprising a first surface and a second surface, wherein the second surface is disposed in opposition to the first surface; a non-permanent and removable adhesive associated with the second surface of the sheet of material and adapted for non-permanently and removably associating the sheet of material with a building structure wall; and a plurality of themed indicia associated with the first surface of the sheet of material.

In accordance with another aspect, the present invention provides a method for celebrating an event. The method generally includes the steps of providing a wallpaper banner comprising an elongate and substantially flat rectangular sheet of material comprising a first surface and a second surface, wherein the second surface is disposed in opposition to the first surface; a non-permanent and removable adhesive associated with the second surface of the sheet of material and adapted for non-permanently and removably associating the sheet of material with a building structure wall; and a plurality of themed indicia associated with the first surface of the sheet of material; and non-permanently associating the wallpaper banner with a dwelling structure wall.

### BRIEF DESCRIPTION OF THE DRAWINGS

These and other features and a more thorough understanding of the invention may be achieved by referring to the following description and claims, taken in conjunction with the accompanying drawings, wherein:

FIG. 1 is a perspective view of a themed indicia displaying wallpaper banner associated with a wall according to the present invention; and

FIG. 2 is a plan view of the wallpaper banner of FIG. 1, wherein the banner includes associated therewith removable themed elements.

### DETAILED DISCUSSION OF EXAMPLE EMBODIMENTS

Disclosed according to the present invention is a temporary and removable wallpaper banner featuring themed indicia thereon, and uses thereof. The wallpaper banner is adapted to be adhered to dwelling structure walls and/or overlays (e.g., paint, wallpaper, paneling, etc.) atop a wall for a selected period of time and to be removed therefrom easily and without causing damage to dwelling structure wall. Additionally, the banner features themed indicia thereon, especially celebratory themed indicia, for enabling individuals to celebrate events, such as holidays, birthdays, graduations, and the like. Because celebrations associated with typical events occur for a limited period of time, the temporary and removable aspects of the banner provide a convenient and useful vehicle for celebrating events.

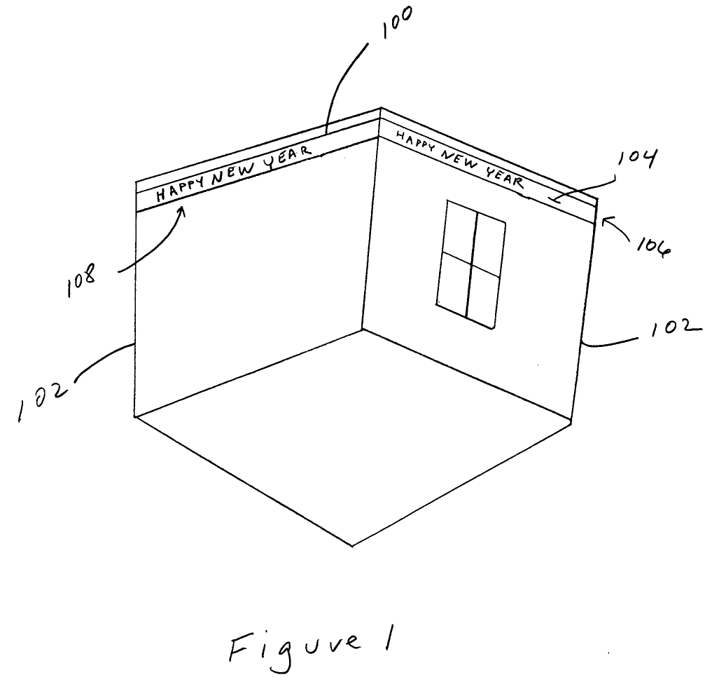

According to a preferred embodiment and with reference to FIG. 1, an example wallpaper banner 100 is generally provided as a thin and elongate rectangular stretch of material having a first surface 104, a second surface 106, themed indicia 110 on the first surface 104, and a non-permanent adhesive associated with the second surface 106. In general, the banner 100 is adapted to be removably associated with a dwelling structure wall 102 in any suitable location and in any suitable configuration. In a preferred embodiment, the banner 100 is adapted to be positioned on a wall 102 in a manner that generally mirrors conventional banner use, namely horizontally disposed atop upper portions 108 of a wall 102.

The wallpaper banner 100 is preferably provided in a configuration corresponding to conventional wallpaper banners. In a preferred embodiment, the banner 100 is configured elongately rectangular, i.e., having a first pair of parallel edges that are significantly longer than a second pair of parallel edges that are disposed generally perpendicularly to the first pair of edges. As will be more fully described hereinafter, the banner 100 is preferably provided commercially in a rolled format for dispensing, according to which the banner 100 is adapted to be disposed continuously between adjacent walls 102, or in any other desired configuration. The banner 100 may suitably also be provided as an elongate rectangular member having one or more cut out portions, such as square cut out portions, adapted for receiving and supporting for display an item, such as a photograph, therebehind, when the banner 100 is associated with a wall 102.

The banner 100 is constructed from any suitable material appropriate for its use in connection with temporary association with a wall 102. For example, the banner 100 may suitably be constructed of a fabric, such as one formed of one or more of cotton, polyester, rayon, etc.; commercial printing paper; a suitable and flexible plastic; nonwoven fabric; vinyl free nonwoven fabrics; cellulose; pulp; rayon; cellulose acetate; polyamide and/or polyester fibers; glass; and the like. The banner 100 material may also be impregnated with various additives, such as styrene-butadiene, acrylic ester copolymer emulsions, other similar resins, and the like. Additionally, the banner 100 is preferably constructed from a material that is breathable (for allowing gases to intermingle with surfaces disposed beneath the banner 100), mold and mildew resistant, fire rated (especially Class A fire rated), durable for avoiding tearing during removal, and the like.

In connection with a preferred embodiment, the wallpaper banner 100 includes themed indicia 110 on its first surface 104. The first surface 104 is preferably a surface of the banner 100 exposed for visual inspection when the banner 100 is positioned atop a wall 102. Accordingly, the themed indicia 110 are provided on the banner 100 in a manner that maximizes its exposure for visual inspection.

The wallpaper banner 100 of the present invention is adapted to display any of a plurality of themed indicia 110, especially indicia related to holiday and/or seasonal indicia, personal and/or family event indicia, hobbies and/or personal interest indicia, and the like. Example holiday and/or season-related indicia include celebratory seasonal displays (e.g., welcoming the advent of a certain season, such as summer, fall, winter, spring), holiday celebratory displays (e.g., celebrating the occurrence of Christmas, Thanksgiving, Halloween, Easter, 4^{th} of July, St. Patrick's Day, New Year's Holiday, Valentine's Day, Hanukkah, etc.). Example personal and/or family indicia include, but are not limited to, announcements and/or celebrations of birthdays, comic birthday announcements, reunion information, new baby announcements, baby shower announcements, wedding shower announcements, graduation congratulations and announcements, gathering, etc. Example hobbies and/or personal interest-related indicia include, but are not limited to, indicia associated with a favored sports team, fishing and/or hunting-themed indicia, golf-themed indicia, patriotic indicia, etc. Additional indicia that may suitably be displayed include, but are not limited to, items that appeal to children (e.g., trucks, cars, lipstick, perfume, etc.), items that are relevant to education (e.g., pencils, apples, scissors, graduation-related items, etc.), over the hill-related indicia, animals, religious-themed indicia (e.g., baptism, communion, etc.), April Fools' Day-related indicia, ocean-related indicia (e.g., ocean views, fish, sea shells, etc.), kitchen-related indicia (e.g., spices, fruit, wine bottles, grapes, grapevines, chef, etc.), outer space-related indicia (e.g., planets, stars, etc.), various colors, optionally including textures), flowers, bugs, grass, baby blocks, alphabet letters, and the like.

In connection with an example embodiment, the wallpaper banner 100 includes themed indicia 110 related to the celebration of New Year's Eve thereon. In connection thereto, the indicia 110 may suitably include such indicia as, for example, textual graphic indicia conveying messages, such as “Happy New Year's”; graphical indicia illustrating festive items typically associated with New Year's celebrations, such as, for example, horns, hats, streamers, champagne flutes, bottles of champagne, and the like.

In connection with another example embodiment, the wallpaper banner 100 includes thereon themed indicia 110 related to the celebration of Valentine's Day thereon. In connection thereto, the indicia 110 may suitably include such indicia as, for example, textual graphic indicia conveying messages, such as “Happy Valentine's Day”; graphical indicia illustrating items typically associated with Valentine's Day, such as, for example, hearts, displays of love and affection, teddy bears, roses, and the like.

In connection with yet another example embodiment, the wallpaper banner 100 includes thereon themed indicia 110 related to the celebration of Christmas thereon. In connection thereto, the indicia 110 may suitably include such indicia as, for example, textual graphic indicia conveying messages, such as “Merry Christmas”; graphical indicia illustrating items typically associated with Christmas, such as, for example, Christmas trees, presents, snow, snowmen, and the like.

Thus, in one aspect, the temporary and removable banner 100 of the present invention provides an advantageous mechanism for celebrating events. Further to the above presented example embodiments, New Year's Eve, Valentine's Day, Christmas, and the like, are events typically celebrated for a limited period of time. Accordingly, the temporary and removable nature of the banner 100 suitably facilitates the celebration of such events.

In connection with an additional example embodiment, the banner 100 includes personalization areas (not illustrated) associated with the themed indicia 110. Such personalization areas may suitably be adapted to receive thereon handwritten indicia for, e.g., enabling individuals to personalize the wallpaper banner 100. The personalization areas may suitably be areas demarcated by graphic indicia (such as a rectangular box) for accentuating display of the personalization areas, and the like. Additionally, the personalization areas may suitably be defined by a layer of material that is particularly adapted to receive handwritten indicia thereon.

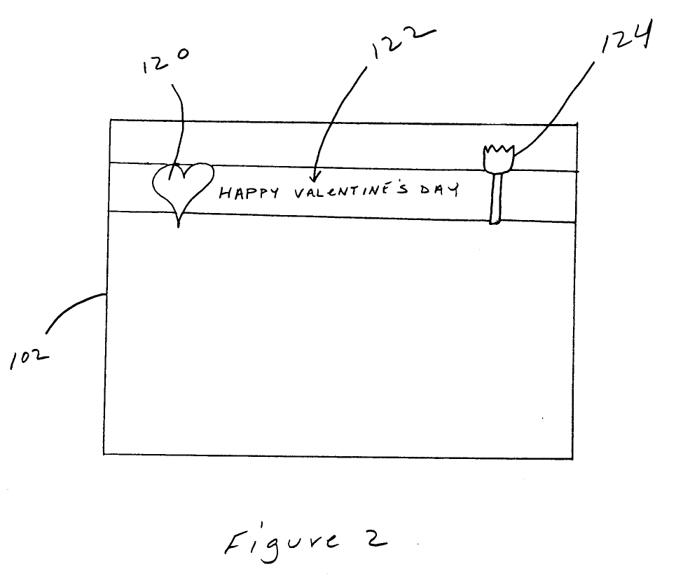

In connection with another example embodiment, the wallpaper banner 100 may suitably various themed elements removably associable therewith. With reference to an example Valentine's Day banner 100 illustrated in FIG. 2, the banner 100 may suitably include removable elements such as, for example, a heart 120, a rose 124, and the like. The removable elements may suitably be constructed from the same, similar or different material used for the construction of the wallpaper banner 100 and may suitably include a non-permanent adhesive, as will be more fully described hereinafter, associated with its rear surface for enabling the removability of the same. Accordingly, an individual may position and reposition the removable elements in any configuration as desired, including directly atop the banner 100, directly atop the wall 102, and the like.

It is to be understood that a plurality of removable elements may be provided, particularly in a configuration and appearance as the themed indicia provided on the banner 100. For example, in connection with example Christmas-related themed indicia, the removable element may be configured to appear as Christmas trees, snowmen, and the like. For additional example, in connection with example New Year's Eve-related themed indicia, the removable elements may be configured to appear as party hats, horns, champagne flutes, and the like.

The themed indicia 110 are provided on the wallpaper banner 100 through any appropriate and conventional technique. For example, the indicia 110 may be imprinted on the banner 100 through silk screening, conventional printing techniques, embossing, lamination, lithography, embroidery, and the like.

In connection with a preferred embodiment, the wallpaper banner 100 is removably associable with a wall 102. Accordingly, the banner 100 second surface 106 includes associated therewith an adhesive that provides the removability of the present invention. The non-permanent adhesive may suitably be provided as any appropriate and conventional adhesive that provides a secure, yet dissociable, association with a wall 102. More preferably, the adhesive is one adapted to removably interfaced with any of a plurality of substrates, such as a painted wall, a paneled wall, a wallpapered wall (especially regardless of the composition of the wallpaper), a brick wall, a cinderblock wall, and the like.

In connection with an example embodiment, the adhesive may suitably be provided as a mastic-like pliable and rubbery adhesive. The banner 100 may suitably be provided commercially in rolled form with the mastic associated therewith, or may suitably be provided with the mastic separately provided on an independent substrate. Accordingly, the banner 100 may be cut to a desired size, and adhered to the wall 102 through the mastic. By way of additional example, the adhesive may suitably be provided as hook and loop fasteners (e.g., Velcro™), double sided tape, double coated foam tape, epoxy-based adhesives that may suitably be temperature sensitive, removable adhesives generally sold under the trademark COMMAND from 3M (St. Paul, Minn.), adhesives typically associated with masking tape, polyvinylether, polyisobutylene, SBR, butyl rubber, polyisobutylene, polyvinyl alkyl ethers and vinyl acetate copolymers and acrylic ester polymers and copolymers thereof, any other conventionally known non-permanent and removable adhesive. Additionally, the adhesive may have materials added thereto for decreasing the adhesive's resistance to removal from the wall 102. An example added material is a silicone compound (e.g., polysiloxane, as described in U.S. Pat. No. 4,151,319 to Sackoff et al., herein incorporated by reference in its entirety.

The adhesive may be associated with second surface 106 of the banner 100 in any appropriate configuration. In one embodiment, the adhesive may be generally extensively disposed atop the second surface 106. In another embodiment, the adhesive may be intermittently distributed in circular arrangements, spotted arrangements, square arrangements, and the like. Preferably, the adhesive is disposed in a manner that maintains an efficient balance between increasing surface contact between the adhesive and the substrate (e.g., wall 102) with which it is associated and minimizing the amount of adhesive disposed on the banner 100. Providing the adhesive intermittently may suitably be advantageous in connection with easing the effort necessary in removing the banner 100 from the wall 102. Additionally, the adhesive is preferably disposed on the banner 100 in a generally uniform thickness, so as to increase the visual appeal of the banner 100 when secured to a wall 102.

The banner 100 of the present invention may suitably be commercially provided in any convenient format. In connection with a preferred embodiment, the banner 100 is provided as a conventional wallpaper banner and is packaged in rolled format, according to which an individual purchases one or more rolls, measures for application, and suitably cuts the roll in the desired length.

With further reference to a commercial embodiment of the banner 100 of the present invention, the banner 100 may suitably include a protective sheet (not illustrated) associated with the second surface 106 thereof in a manner that prevents unwanted association of the adhesive thereon to various elements. The protective sheet may suitably be constructed of an appropriate paper, plastic, and the like and be removably disposed atop the adhesive, which sheet is removed prior to application of the banner 100 to a wall 102.

In connection with another example embodiment, the banner 100 of the present invention may suitably be configured to, either alone or together with a length of banner 100, operate as a picture frame. In one embodiment, the banner 100 may suitably be modified to include a generally rectangular portion with an open middle area. The rectangular portion preferably includes a removable adhesive along a rear side thereof. Accordingly, a picture or similar item may be positioned generally in association with the open middle area, with edge portions thereof suitably resting behind the rectangular portion. Accordingly, when the banner 100, in this embodiment, it removably associated with a wall, the picture positioned behind the open middle area is maintained along the wall through cooperation of the rectangular portion with both the wall and the picture. Thus, the banner 100 may suitably operate as a removable picture frame.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

What is claimed is:

1. A removable wallpaper banner having themed indicia thereon, wherein the wallpaper banner comprises:
an elongate and substantially flat rectangular sheet of material comprising a first surface and a second surface, wherein the second surface is disposed in opposition to the first surface;
a non-permanent and removable adhesive associated with the second surface of the sheet of material and adapted for non-permanently and removably associating the sheet of material with a building structure wall; and
a plurality of themed indicia associated with the first surface of the sheet of material.

2. The removable wallpaper banner of claim 1 further comprising at least one themed element removably associable with the banner first surface.

3. The removable wallpaper banner of claim 1, wherein the themed indicia comprises at least one of textual indicia and graphic indicia.

4. The removable wallpaper banner of claim 3, wherein the themed indicia is related to at least one of a holiday-related theme, a seasonal theme, a birthday-related theme, a birth-related theme, a wedding-related theme, a personal hobby-related theme, a patriotism-related theme, and a sports affiliation-related theme.

5. The removable wallpaper banner of claim 4, wherein the holiday-related theme is at least one of a Christmas-related theme, a Thanksgiving-related theme, a Halloween-related theme, an Easter-related theme, a 4^{th} of July-related theme, a St. Patrick's Day-related theme, a New Year's-related theme, and a Valentine' Day-related theme.

6. The removable wallpaper banner of claim 4, wherein the seasonal theme is at least one of a Spring season-related theme, a Summer season-related theme, a Fall season-related theme, and a Winter season-related theme.

7. The removable wallpaper banner of claim 2, wherein the removable themed element is configured to appear as an article associated with at least one of a holiday-related theme, a seasonal theme, a birthday-related theme, a birth-related theme, a wedding-related theme, a personal hobby-related theme, a patriotism-related theme, and a sports affiliation-related theme.

8. The removable wallpaper banner of claim 7, wherein the removable themed element is configured to appear as at least one of a Christmas tree, a snowman, a gift, a Valentine's Day heart, a rose, a teddy bear, a shamrock, a champagne bottle, a champagne flute, an Easter bunny, an Easter egg, a turkey, a pumpkin, a ghost, and a gravestone.

9. The removable wallpaper banner of claim 1, wherein the elongate and substantially flat rectangular sheet of material further comprises at least one aperture therein for displaying an article in association with the wallpaper banner when the article is maintained between the banner second surface and a wall to which the banner is affixed.

10. The removable wallpaper banner of claim 9, wherein the article displayed in association with the banner aperture is at least one of a photograph, and a paper comprising artwork thereon.

11. The removable wallpaper banner of claim 1, wherein the banner first surface comprises at least one personalization portion thereon adapted for receiving and displaying handwritten indicia.

12. A method for celebrating an event comprising the steps of:
providing a wallpaper banner comprising
an elongate and substantially flat rectangular sheet of material comprising a first surface and a second surface, wherein the second surface is disposed in opposition to the first surface;
a non-permanent and removable adhesive associated with the second surface of the sheet of material and adapted for non-permanently and removably associating the sheet of material with a building structure wall; and
a plurality of themed indicia associated with the first surface of the sheet of material; and
non-permanently associating the wallpaper banner with a dwelling structure wall.

13. The method of claim 12 further comprising the step of non-permanently associating a themed element with the wallpaper banner first surface.

14. The method of claim 12, wherein the themed indicia comprises at least one of textual indicia and graphic indicia.

15. The method of claim 14, wherein the themed indicia is related to at least one of a holiday-related theme, a seasonal theme, a birthday-related theme, a birth-related theme, a wedding-related theme, a personal hobby-related theme, a patriotism-related theme, and a sports affiliation-related theme.

16. The method of claim 15, wherein the holiday-related theme is at least one of a Christmas-related theme, a Thanksgiving-related theme, a Halloween-related theme, an Easter-related theme, a 4^{th} of July-related theme, a St. Patrick's Day-related theme, a New Year's-related theme, and a Valentine' Day-related theme.

17. The method of claim 15, wherein the seasonal theme is at least one of a Spring season-related theme, a Summer season-related theme, a Fall season-related theme, and a Winter season-related theme.

18. The method of claim 13, wherein the removable themed element is configured to appear as an article associated with at least one of a holiday-related theme, a seasonal theme, a birthday-related theme, a birth-related theme, a wedding-related theme, a personal hobby-related theme, a patriotism-related theme, and a sports affiliation-related theme.

19. The method of claim 18, wherein the removable themed element is configured to appear as at least one of a Christmas tree, a snowman, a gift, a Valentine's Day heart, a rose, a teddy bear, a shamrock, a champagne bottle, a champagne flute, an Easter bunny, an Easter egg, a turkey, a pumpkin, a ghost, and a gravestone.

20. The method of claim 12, wherein the elongate and substantially flat rectangular sheet of material further comprises at least one aperture therein for displaying an article in association with the wallpaper banner when the article is maintained between the banner second surface and a wall to which the banner is affixed.

21. The method of claim 20 further comprising the step of disposing an article between the banner and a wall to which the banner is affixed, and in association with the banner aperture.

22. The method of claim 21, wherein the article displayed in association with the banner aperture is at least one of a photograph, and a paper comprising artwork thereon.

23. The method of claim 12 further comprising the step of imprinting handwritten indicia on a personalization surface of the wallpaper banner.
